(19) United States
(12) Patent Application Publication
(10) Pub. No.: US 2022/0235604 A1
(43) Pub. Date: Jul. 28, 2022

(54) DOOR ASSEMBLY

(71) Applicant: CLARK DOOR LIMITED, Cumbria (GB)

(72) Inventors: Patrick OWEN, Derbyshire (GB); Paul ASHLEY, Cumbria (GB)

(21) Appl. No.: 17/585,671

(22) Filed: Jan. 27, 2022

(30) Foreign Application Priority Data
Jan. 27, 2021 (GB) 2101067.3

(51) Int. Cl. E06B 9/17; E06B 9/13

(52) U.S. Cl. CPC E06B 9/17076; E06B 9/13

(57) ABSTRACT

A door assembly, for an opening in a building, comprising a sealing assembly, wherein the sealing assembly is configured to seal a gap (36) between the rolling shutter door (4), the opening, and a surface of the building proximal the opening. The seal comprises a resiliently deformable member (48), and a sealing member (46), mutually positioned such that the resiliently deformable member co-operates with the sealing member when the rolling shutter door is in the closed position to seal the gap, which prevents or mitigates passage of sound, smoke, heat, and the like through the gap. The door assembly is preferably an acoustically-insulating door assembly.

### CROSS REFERENCE TO RELATED APPLICATION

This application claims priority to United Kingdom Application No. 2101067.3 filed Jan. 27, 2021, the entire contents of which are herein incorporated by reference.

The present invention relates to a door assembly, for an opening in a building, comprising a sealing assembly, wherein the sealing assembly is configured to seal a gap between a rolling shutter door, the opening, and a surface of the building proximal the opening. The present invention further relates to a sealing assembly for a door assembly, in particular an acoustic sealing assembly.

### BACKGROUND

Door assemblies comprising a rolling shutter door are used in a variety of buildings, for example, in domestic, industrial, commercial, and public buildings. Door assemblies comprising a rolling shutter door may be particularly useful as fire doors, security doors or as insulating doors.

Rolling shutter doors are typically flexible. This allows the rolling shutter door to be retracted from a closed position in which the rolling shutter door occludes the opening in the building (i.e. closes it off completely), to an open position in which the opening is at least partially clear of occlusion by the rolling shutter door (i.e. the opening is at least partially open). To move the rolling shutter door from a closed to an open position, the rolling shutter door is typically rolled about a barrel positioned above, or to one side of, the opening in the building. Conversely, the rolling shutter door may be unrolled from the barrel to move the rolling shutter door from an open position to a closed position.

The size of the coil of rolling shutter door about the barrel changes depending on whether the rolling shutter door is rolled around the barrel or unrolled from the barrel. As the rolling shutter door is unrolled from the barrel, the diameter of the rolled door about the barrel decreases. In other terms, the distance between the barrel and the outermost surface of the rolling shutter door rolled around the barrel decreases as the rolling shutter door is unrolled from the barrel. To accommodate the changing size of the roll of rolling shutter about the barrel between the open and closed positions, a gap is provided between the rolling shutter door, the opening, and the surface of the building proximal the opening. Sound, smoke, heat and the like may undesirably leak through this gap when the rolling shutter door is in a closed position.

FIG. 1 illustrates such a prior art door assembly 2, which is described by way of example. The person skilled in the art will appreciate that the sealing assembly according to the present invention equally may be used with alternative door assemblies.

With reference to FIG. 1, the door assembly 2, and more particularly a rolling shutter door 4, is positioned to occlude an opening in a building (building not illustrated). The opening may be defined by, for example, an upper wall and two side walls, and may be of any suitable dimensions.

The rolling shutter door 4 is provided in a fully closed position wherein the opening is occluded. The rolling shutter door 4 comprises a plurality of interlocking laths 6, which provides flexibility to the rolling shutter door 4.

The rolling shutter door 4 is attached to a barrel 20, which can be rotated about its longitudinal axis clockwise or anti-clockwise depending on the configuration of the door assembly. The barrel 20 can be rotated to coil the rolling shutter door 4 about itself, thus moving the rolling shutter door 4 from a closed position to an open position. Mechanical means, such as a motor 30, is provided to assist in rotating the barrel, although the barrel may additionally or alternatively be rotated manually (e.g. by means of a pulley system or a crankshaft). In its open position, the portion of the rolling shutter door rolled about the barrel 20 has an arcuate configuration, in the manner of a spiral or coil. In its closed position, the portion of the rolling shutter door 4 at least partially occluding the opening 14 has a substantially planar configuration.

The rolling shutter door 4 is provided with a bottom rail 10. The bottom rail 10 reinforces the rolling shutter door 4 to provide additional strength. As such, the bottom rail 10 may be made of a reinforced material such as, but not limited to, steel. The bottom rail 10 also comprises a blocking member 12 to protect the bottom rail 10 from damage. The blocking member 12 may be provided in the form of a protruding bar as illustrated in FIG. 1.

The rolling door 4 is further provided with protection straps 34 to protect the rolling shutter door when moving between the closed and an open position, as illustrated in FIG. 1. In particular, one or more protection straps 34 may be provided to protect the rolling shutter door 4 when it is coiled around the barrel 20 when the door is in an open position. The protection straps 34 are generally provided on a surface of the rolling shutter door 4, which faces the interior of the building. The protection straps 34 are generally made of an elastic material to provide cushioning to the rolling shutter door 4 in the open position (when coiled around the barrel 20). As the rolling shutter door 4 is unrolled from barrel 20 as the door is moved into the closed position, the protection straps 34 cushion the rolling shutter door 4. Moreover, the protection straps 34 may provide additional structural integrity to the rolling shutter door 4 when in the closed position. The protection straps may also reduce noise when the rolling shutter door is moved between open and closed positions.

The barrel 20 is supported by a pair of support brackets 22. The support brackets are provided with one or more apertures 24, for inserting fixtures and fittings (e.g. screws, nail, bolts, and the like), to secure the support brackets 22 to the building in which the opening is defined (e.g. to the top wall defining the opening in the building). A lintel portion 18 of the door assembly 2 collectively comprises the barrel 20 and the support brackets 22. The lintel portion 18 is positioned above the opening. The barrel 20 is positioned horizontally with respect to the ground G. The rolling shutter door 4 is therefore configured to open vertically in the direction of arrow A with respect to the ground G upon rotation of the barrel 20.

Although the illustrated embodiments depict the barrel 20 being horizontally positioned with respect to the ground G, such that the rolling shutter door 4 opens vertically, those skilled in the art will appreciate that the barrel 20 could equally be positioned vertically with respect to the ground G to provide a rolling shutter door 4 that opens horizontally. Therefore, in embodiments of the present invention described herein, the rolling shutter door 4 may move between the open position and the closed position in a horizontal manner.

The rolling shutter door assembly 2 comprises a pair of guide members 16 configured to guide the rolling shutter door 4 between an open position and the closed position. The guide members 16 may be substantially parallel with respect to one another, and provide a track in which the rolling shutter door 4 is secured as it moves between the open position and the closed position. The guide members 16 are provided with one or more apertures 32 which are suitable for inserting fixtures and fittings, to secure the guide members 16 to a surface of the building (e.g. to the side walls defining the opening in the building).

FIG. 2 illustrates the door assembly of FIG. 1 in its fully open position to reveal opening 14. The opening allows passage between one side S1 of the door assembly, to another side S2 of the door assembly. S1 may be the interior of a building, and S2 may be the exterior of a building. FIG. 3 illustrates the door assembly of FIGS. 1 and 2 wherein the rolling shutter door 4 partially occludes the opening 14. As such, the rolling shutter door 4 is only partially coiled about the barrel 20. In the closed position as illustrated in FIG. 1, the rolling shutter door 4 occludes the opening. The opening may be of any suitable height H or width W.

FIGS. 4 and 5 illustrate end views of the lintel portion 18 comprising the barrel 20. As shown in FIG. 4, a housing 18a may be provided (not illustrated in FIGS. 1-3) about the barrel 20 and support brackets 22. The housing 18a protects the barrel 20 and the rolling shutter door 4, when the rolling shutter door 4 is in its open position. The housing 18a may also be provided to screen the barrel 20 and support brackets 22 (e.g. for aesthetic purposes).

A portion of the rolling shutter door 4 comprising a plurality of laths 6 is illustrated in FIGS. 4 and 5. The plurality of laths 6 are configured such that the rolling shutter door 4 is flexible. The plurality of laths 6 may each comprise one or more interlocking members 8 (e.g. via a snap-fit arrangement) configured to allow connection of a lath 6 to an adjacent lath. The plurality of laths may be connected by any suitable means known to those skilled in the art. The interlocking members 8 are configured to allow a lath 6 to be connected to an adjacent lath 6 such that each lath 6 is pivotable with respect to one another, thus providing a flexible rolling shutter door 4. The rolling shutter door 4 may comprise a plurality of adjacent laths 6 comprising interconnecting members 8.

Although the present invention is described with reference to a rolling shutter door comprising a plurality of laths, those skilled in the art will appreciate that other types of rolling shutter door are envisaged within the scope of the present invention. For example, the rolling shutter door 4 may be of continuous construction. For example, the rolling shutter door 4 may comprise a continuous sheet of a suitable flexible material (e.g. flexible textiles (such as cloths), elastomeric materials, rubbers, and plastics (such as but not limited to: polyester, polyvinylchloride).

The rolling shutter door 4 is attached to the barrel by fixing means 28, for example by means of nuts and bolts as illustrated in FIG. 16. The rolling shutter door 4 is attached to the barrel 20 an upper latitudinal edge 26 (that is to say, an edge of the door that is in use is substantially horizontal with respect to the ground, and is on an opposite edge to that of bottom rail 10). The upper latitudinal edge 26 may include at least the uppermost lath 6a (and optionally one or more laths 6 adjacent the uppermost lath 6a) of the rolling shutter door 4. The rolling shutter door 4 may be attached to the barrel 20 by any suitable fixing means, for example by means of bolts, nuts, rivets, screws, nails, and the like. With reference to FIG. 16, the barrel comprises an indentation 20a to accommodate the upper latitudinal edge 26 (e.g. uppermost lath 6a) of the rolling door, such that the first coil of the rolling shutter door 4 is provided in a substantially circular shape. The indentation 20a therefore allows for subsequent coils of the rolling door to wrap around the first coil of the rolling shutter door in an efficient manner. The uppermost lath(s) 6a may be made of a reinforced material, or have an increased thickness (relative to other laths at a lower position in the rolling door), to provide additional support at the points, which the rolling shutter door 4 is attached to the barrel.

The rolling shutter door 4 is attached to the barrel 20 at one or more portions of the rolling shutter door 4. With reference to FIG. 16, the rolling shutter door 4 is attached to the barrel 20 at least two laths 6 of the rolling shutter door 4 by fixing means 28 (e.g. bolts and nuts). In particular, FIG. 16 shows the rolling shutter door 4 fixed at an uppermost lath 6a, and at an intermediate lath 6b. The uppermost lath 6a may be rigidly fixed to the barrel (i.e. is tightly secured to the barrel, and does not move relative to the barrel). The intermediate lath 6b may be loosely fixed (i.e. is not tightly bound to the barrel, and has some flexibility to move [e.g. pivot] about the barrel). The intermediate lath 6b is selected such that the rolling shutter door 4 when in the closed position is provided with one full coil about the barrel. Providing fixing means 28 at an uppermost lath 6a and an intermediate lath 6b as illustrated in FIG. 16 provides increased strength to the door assembly 2. In particular, the increased strength of the door assembly 2 mitigates the risk of damage to the rolling shutter door 4 and the barrel 20 when moving between the open and closed positions. Fixing an intermediate lath 6b and uppermost lath 6a further means that the weight of the curtain is distributed around the barrel, and further provides means of locking the rolling shutter door when in the closed position (i.e. prevents the rolling shutter door 4 being lifted from the bottom).

The rolling shutter door 4 may additionally be attached to the barrel 20 by one or more portions across its longitudinal dimension (i.e. its width). FIG. 16 depicts fixing means 28 in cross-section, but the skilled person will appreciate that several such cross-sections may be present along the width of the rolling shutter door 4 and barrel 20.

With reference to FIGS. 4 and 5, the dashed lines about the barrel 20 represent an outer extremity of the rolling shutter door 4 when the rolling door 4 is rolled about the barrel 20 in an open position, or when the rolling door 4 is unrolled from the barrel 20 in a closed position. The size of the roll changes as the rolling shutter door 4 moves from an open position (coiled about the barrel), to an open position (at least partially unrolled from the barrel). Referring to FIG. 4, when the rolling shutter door 4 is rolled around the barrel 20 to provide the rolling shutter door in an open position, the distance between the barrel 20, and the outmost, outwardly facing surface of rolling shutter door 4 is distance D1. With reference to FIG. 5, when the rolling shutter door 4 is unrolled from the barrel 20 to provide the rolling shutter door in a closed position, the distance D2 is less than distance D1. Door assemblies comprising rolling shutter doors therefore have a lintel portion 18, which can accommodate the difference in distances D1 and D2. This may be achieved through positioning the barrel 20 and the supporting brackets 22 relative to the wall of the building defining the opening (e.g. a top wall), such that enough clearance is provided between the barrel, the rolling shutter door, and a wall of the building proximal the opening. As shown in FIG. 4, the bottom rail 10 and lowermost lath 6 are retained in the guide members 16 to prevent the rolling shutter door 4 from becoming loose. Adequate clearance is required to allow the rolling shutter door to be freely moved into a fully open position (i.e. the rolling shutter door 4 does not occlude the opening 14).

The provision of adequate space to accommodate the roll of rolling shutter door 4 in the lintel portion 18 when rolled about barrel 20 leads to a gap 36 between the rolling shutter door 4, the opening 14, and a surface 14a of the building proximal the opening (e.g. a top wall defining and positioned above an opening in a building). The surface 14a proximal the opening 14 illustrated in FIG. 4 may form part of the interior of the building (e.g. an interior top wall defining and positioned above an opening in a building). As shown, the gap 36 is at least partially defined by a surface of the rolling shutter door 4. The surface of the rolling shutter door 4 is an exterior-facing surface, relative to the building (that is to say a surface of the rolling shutter door which faces towards the exterior S2 of the building in a closed position). Alternatively, the surface of the rolling shutter door 4 is interior facing relative to the building (that is to say a surface of the rolling shutter door which faces towards the interior S1 of the building in a closed position).

As shown in FIGS. 4 and 5, the gap 36 is formed between an exterior-facing surface of the rolling shutter door 4 (that is facing towards the exterior S2 of the building), a surface 14a positioned above, and adjacent to, the opening 14 (which may be a top wall defining the opening 14 in a building), and the opening 14. The lintel portion 18 comprising barrel 20 and support brackets 22 are accommodated in the interior side S1 of a building.

When the rolling shutter door is in a closed position, the gap 36 is a route through which sound, smoke, heat and the like may undesirably leak into the lintel portion 18. If the lintel portion 18 is not provided with a housing 18a, then the gap 36 is a route for smoke, heat, sound and the like to directly enter into the interior side S1 of the building. If the lintel portion is provided with a housing 18a, then the housing 18a can harbour smoke, heat, sound and the like before emanating therefrom into the interior S1 of the building. The presence of the gap 36 therefore compromises (negatively impacts) the performance of door assemblies comprising rolling shutter doors, particularly insulating door assemblies (e.g. thermally insulated door assemblies, acoustically insulated door assemblies).

A sealing assembly comprising a brush head has been proposed to provide closure of this gap, but it has been found that such seals provide sub-optimal insulating performance, and, in particular, poor acoustic insulating performance.

FIGS. 6 and 7 depict a prior art sealing assembly 38, which extends across the gap 36 from surface 14a of the building in which the door assembly is installed, to a surface of the rolling shutter door 4, to provide a seal (brush seal). The sealing assembly 38 comprises a brush head 40 and a bracket 42. The bracket 42 is fixed to surface 14a of the building that is proximal or adjacent opening 14, and the brush head 40 extends horizontally from the bracket 42 across the gap 36. The tip of the brush head 40 contacts a surface of the rolling shutter door (for example the exterior-facing surface of the rolling shutter door) to provide a seal. Sealing assemblies comprising a brush head 40 (such as that illustrated in FIGS. 6 and 7) provide a poor seal that does not adequately prevent sound, smoke, heat and the like entering the lintel portion 18 through gap 36. The brush head 40 does not adequately prevent sound, smoke, heat and the like entering the interior side S1 of the building from the exterior side S2 of the building, or vice versa. The bristles of the brush allow passage of sound, smoke, heat and the like to pass freely between the bristles. Moreover, the top of the brush head 40 only contacts the rolling shutter door 4, and does not form a tight seal. Further still, over time, the bristles of the brush head 40 may become worn through contact with the rolling shutter door 4 as it moves between the open and closed positions, thus further reducing the efficiency of the brush seal.

There is therefore a need for an improved seal for door assemblies comprising a rolling shutter door, particularly acoustically insulating door assemblies, and thermally insulating door assemblies. More particularly, there is a need for a seal, which provides adequate acoustic and/or thermal insulation for the gap 36 in a door assembly.

It is an object of the present invention to address one or more of the problems outlined above.

### SUMMARY OF INVENTION

According to a first aspect of the present invention, there is provided door assembly for an opening in a building, wherein the door assembly is installable to the opening. The door assembly comprises a rolling shutter door moveable between a closed position wherein the opening is occluded by the rolling shutter door, and an open position wherein the opening is at least partially clear of occlusion by the rolling shutter door. The door assembly further comprises a sealing assembly for sealing a gap between the rolling shutter door, the opening, and a surface of the building proximal the opening. The seal comprises a resiliently deformable member, and a sealing member. The resiliently deformable member and sealing member are each mutually positioned such that the resiliently deformable member co-operates with the sealing member when the rolling shutter door is in the closed position to seal the gap.

Advantageously, the resiliently deformable member and sealing member co-operate when the rolling shutter door is in the closed position to provide a seal, which prevents or mitigates passage of sound, smoke, heat, and the like through the gap. The sealing assembly according to the present invention therefore improves the performance of the rolling shutter door assembly. Moreover, the sealing assembly according to the present invention is advantageously configured to form a seal when the rolling shutter door is in the closed position, but is configured to allow free movement of the rolling shutter door between the open and closed positions.

The resiliently deformable member may comprise a resiliently deformable sheet. In embodiments, the resiliently deformable mating member is one or more resiliently deformable sheets as described herein. Preferably, the resiliently deformable member is a resiliently deformable sheet. Advantageously, the resiliently deformable sheet may configured to have sealing and non-sealing configurations, as described in more detail herein.

Preferably, the resiliently deformable member is positioned on a surface of the rolling shutter door. Advantageously, providing the resiliently deformable member positioned on the rolling shutter door means the sealing member and resiliently deformable member can be mutually positioned, such that the seal forms when the rolling shutter door is in a desired position (i.e. the closed position)

Optionally said surface of the rolling shutter door faces the exterior of the building when in a closed position. This means that the gap is provided with a seal before smoke, heat, sound and the like can emanate into the interior of the building, leading to an improvement in performance of the rolling shutter door assembly.

Preferably, the resiliently deformable member is positioned on an upper portion of the surface of the rolling shutter door. This means that the rolling shutter door can be moved into a fully closed position before the sealing assembly forms the seal across the gap. Allowing the rolling shutter door to move into the fully closed position again improves the overall performance (e.g. acoustic insulation, thermal insulation) of the rolling shutter door assembly.

In embodiments, the resiliently deformable member is attached to the rolling shutter door by attachment means, preferably by attachment means at portions of the resiliently deformable member that are proximal to the outer perimeter of the resiliently deformable member (e.g. towards the edges of the resiliently deformable member). In embodiments, the resiliently deformable member is affixed to the rolling shutter door at least at an upper edge of the resiliently deformable member, and at a lower edge of the resiliently deformable member. In other words, the resiliently deformable member may be affixed to the rolling shutter door at two edges, rather than at a single edge leaving one edge unaffixed. The upper and lower edges of the resiliently deformable member are in relation to an upper and lower portions of the rolling shutter door either side of the resiliently deformable member, to which the resiliently deformable member is attached. A central portion of the resiliently deformable member is free of the rolling shutter door (i.e. the central portion is not affixed to the rolling shutter door) allowing the resiliently deformable member to move freely between the sealing and non-sealing configurations.

The sealing member is mutually positioned relative to the resiliently deformable member to co-operate when the rolling shutter door is in the closed position to form the seal.

Preferably, the sealing member may be positioned on an interior wall of the building, proximal the opening therein. This means that the sealing member can cooperate with the resiliently deformable member, before heat, smoke, sound and the like can emanate into the interior of the building.

Optionally the sealing member may be positioned above the opening. Although the sealing member may be positioned on any wall of the building (e.g. an upper wall) that defines the opening, it may alternatively be positioned within the lintel portion of the door assembly (e.g. on an interior wall of the housing that houses the barrel and/or support brackets).

Preferably, the resiliently deformable member may have a sealing configuration when the rolling shutter door is in the closed position and a non-sealing configuration when the rolling shutter door is in the open position, and optionally a non-sealing configuration when the rolling shutter door is in a partially open position. Provision of a non-sealing configuration allows the resiliently deformable member to be removed from cooperation with the sealing member when the seal is not required; thus enabling the rolling shutter door to be freely moved between the open and closed positions.

Further preferably, the resiliently deformable member may protrude from the surface of the rolling shutter door in the sealing configuration. For example, the resiliently deformable member may be urged to protrude away from laths of the rolling shutter door, when the rolling shutter door is in a closed position (e.g. when a portion of the rolling shutter door on which the resiliently deformable member is positioned is in a planar configuration). In such embodiments, the resiliently deformable member has sufficient rigidity to maintain the sealing configuration. Advantageously, the resiliently deformable member extends away from a surface of the rolling shutter door towards the mutually positioned sealing member. As such, the protruding resiliently deformable member bridges the gap to cooperate with the sealing member to provide a seal across the gap.

The resiliently deformable member may be deformed (e.g. flexed) into the sealing and/or non-sealing configuration.

The resiliently deformable member may be deformed into the sealing configuration by movement of the rolling shutter door from a closed position to an open position, and is able to relax back into the non-sealing configuration by movement of the rolling shutter door from a closed position to an open position. The resiliently deformable member may be deformed into the sealing configuration by movement of the rolling shutter door from an arcuate configuration to a planar configuration, and is able to relax back into the non-sealing configuration by movement of the rolling shutter door from a planar configuration to an arcuate configuration.

Alternatively, the resiliently deformable member may be deformed into the non-sealing configuration by movement of the rolling shutter door from a closed position to an open position, and is able to relax back into the sealing configuration by movement of the rolling shutter door from a closed position to an open position. The resiliently deformable member may be deformed into the non-sealing configuration by movement of the rolling shutter door from an arcuate configuration to a planar configuration, and is able to relax back into the sealing configuration by movement of the rolling shutter door from a planar configuration to an arcuate configuration.

The resiliently deformable member may be made from any suitable material, for example but not limited to, plastics, flexible textiles (e.g. fabrics, cloths), rubber, plastics, elastomeric materials and the like, and optionally combinations thereof. Preferably, the resiliently deformable member comprises, or consists of, a reinforced plastic material, such as reinforced polyvinyl chloride sheets.

In use, when the rolling shutter door is in an arcuate configuration in the open position, the resiliently deformable sheet may complement the configuration of the rolling shutter door. Advantageously, the resiliently deformable member may not inhibit the rolling shutter door moving between open and closed positions. The resiliently deformable member can simply complement the configuration of the rolling shutter door, and be effectively rolled up with the rolling shutter door when in the open position.

Preferably, the non-sealing configuration of the resiliently deformable member may be complementary to an arcuate conformation of the rolling shutter door when the rolling shutter door is in the open position. When in the open position, the rolling shutter door is rolled about barrel, and as such has an arcuate configuration in the manner of a coil or spiral. The resiliently deformable member may complement the configuration (e.g. arcuate) of the rolling shutter door when rolled about the barrel. In other words, the resiliently deformable member may have an arcuate configuration in the non-sealing configuration, which resembles a portion of the circumference of a coil of the rolling door, when coiled about the barrel.

The resiliently deformable member may be under tension (e.g. stretch) across the portion of the rolling shutter door to which it is attached, when in the non-sealing configuration. Alternatively, the resiliently deformable member may be in a resting state (i.e. not under tension), when in the non-sealing configuration.

The resiliently deformable member may be further provided with a protecting member, which may be positioned on a portion of the rolling shutter door (e.g. a lath) underneath the resiliently deformable member. Advantageously, the protecting member mitigates strain on the resiliently deformable member when in the non-sealing configuration. The protecting member may be a resiliently deformable material (e.g. a sponge-like material) to cushion the resiliently deformable member against the rolling shutter door. In embodiments, the resiliently deformable material may urge the resiliently deformable member from a non-sealing configuration into a sealing configuration.

One or more resiliently deformable members may be provided across the width of the rolling shutter door. Preferably, the resiliently deformable member may be of continuous construction, and extend substantially across the entire width of the rolling shutter door. Where one or more resiliently deformable members are provided, or wherein a resiliently deformable member of continuous construction is provided, one or more complementary sealing members may be provided to co-operate with the resiliently deformable members.

Preferably, the sealing member may have a mating configuration when the rolling shutter door is in the closed position and a resting configuration when the rolling shutter door is in the open position, said mating and resting configurations being different configurations.

Alternatively, the mating and resting configurations of the sealing member may be the same. The sealing member may have a mating and resting configuration that is inherently complementary to the sealing configuration of the resiliently deformable member. For example, the sealing member may be made of an injection moulded plastic or rubber, configured to cooperate with the sealing configuration of the resiliently deformable member.

Preferably, the mating configuration of the sealing member may be complementary to the sealing configuration of the resiliently deformable member. Such configurations provide a close sealing arrangement, to mitigate passage of smoke, heat, sound and the like through the gap and into the interior of the building. Of course, non-complementary configurations may be envisaged, but it is preferred that the mating configuration of the sealing member is complementary to the sealing configuration of the resiliently deformable member to provide the most effective seal possible.

Preferably, the sealing member may protrude towards the interior of the building when the sealing member is in the resting configuration. This means the sealing member bridges a portion of the gap, to be in closer proximity to the resiliently deformable member when in the sealing configuration.

The sealing member may comprise a cavity, optionally wherein the cavity is at least partially filled with an insulating material. The cavity may be at least partially filled with an insulating material, which improves the performance of the rolling shutter door assembly.

The cavity may be defined between the sealing member, and a portion of a wall defining the opening. Alternatively, where a lintel portion is provided in the rolling shutter door assembly, the cavity may be defined between the sealing member and the lintel portion (e.g. an interior of a housing containing the barrel and support brackets). Alternatively still, the sealing member may further comprise a frame, which at least partially defines the cavity.

Preferably, the sealing member may be resiliently deformable. As such, both the resiliently deformable member and the sealing member may be resiliently deformable.

The sealing member may be deformed (e.g. flexed) into the mating and/or resting configuration.

The sealing member may be deformed into the mating configuration by contact with the resiliently deformable member. As such, in use, the resiliently deformable member may cooperate with the sealing member causing the sealing member to deform thus forming the seal.

Preferably, the sealing member is comprised of a more flexible material than the resiliently deformable member. Advantageously, this means that the resiliently deformable member is capable of deforming the sealing member into the mating configuration to form the seal when the door is in the closed position.

The sealing member may be urged from the mating configuration back into the resting configuration by means of a resiliently deformable insulating material provided in the cavity of the sealing member. When the seal is broken (i.e. the rolling shutter door is in the open position), the resiliently deformable insulating material may expand to urge the sealing member into its resting state. When the seal is formed (i.e. the rolling shutter door is in the closed position) the resiliently deformable insulating member deforms with the sealing member into the mating configuration. Alternatively, the sealing member may return back to the resting configuration from the mating configuration of its own volition.

The sealing member may comprise a resiliently deformable mating member. The resiliently deformable mating member may be made of a more flexible material than the resiliently deformable member. The resiliently deformable mating member may comprise a resiliently deformable sheet. In embodiments, the resiliently deformable mating member is one or more resiliently deformable sheets as described herein. Preferably, the resiliently deformable member is a continuous resiliently deformable sheet.

The sealing member (optionally the resiliently deformable mating member) and the resiliently deformable member may both comprise one or more resiliently deformable sheets. As described above, preferably, the sealing member is more flexible than the resiliently deformable member. In such embodiments, the sealing member may comprise a resiliently deformable sheet that is thinner than the resiliently deformable member. Additionally or alternatively, the sealing member may comprise a resiliently deformable sheet that is made of a more flexible material than the resiliently deformable member. In instances, the sealing member (and optionally the resiliently deformable mating member) may comprise, or consist of a polyester reinforced polyvinyl chloride sheet (e.g. Tarpol™). In instances the resiliently deformable member comprise, or consist of a polyvinyl chloride sheet.

When in the sealing configuration, the resiliently deformable member may cooperate with the resiliently deformable mating member to induce the resiliently deformable mating member into the mating configuration from the resting configuration. Advantageously, providing a sealing assembly, which cooperates by means of an induced fit, provides a tight seal that efficiently mitigates the passage of smoke, heat, sound and the like through the gap and into the interior of the building. The seal provided by the induced fit advantageously means that the sealing member and the resiliently deformable member adopt complimentary configurations, and fit tightly together, without gaps.

The sealing member may comprise or consist of the resiliently deformable mating member. The resiliently deformable member may be positioned directly on a wall (e.g. an upper wall above an opening) of the building defining the opening. A cavity may be provided between the resiliently deformable mating member and the wall to which the sealing member may be fixed. The cavity may be at least partially filled with an insulating (e.g. acoustically insulating) material to improve the performance of the door assembly.

In embodiments, the cavity is at least partially filled with a resiliently deformable insulating material, wherein the resiliently deformable insulating material urges the resiliently deformable mating member from the mating configuration into the resting configuration, when the rolling shutter door is in the open position.

Preferably, the interface between the sealing member and the resiliently deformable member when cooperating to provide the seal may be smooth (i.e. free from visible projections, indentations, recesses, lumps and the like). In other words, the portions of the sealing member and resiliently deformable member which come into contact to form the seal may be smooth, so as to reduce friction when the rolling shutter door moves between the closed position (and a seal is provided) to an open position (the seal is disengaged).

The sealing member may extend across the substantially the entire width of the rolling shutter door. Alternatively or additionally, one or more sealing members may be provided across the width of the rolling shutter door. One or more resiliently deformable members may be mutually positioned to contact one or more sealing members when the rolling shutter door is in the closed position.

In use, when the rolling shutter door is moved from the closed position to the open position, the resiliently deformable member may flex to allow the seal to be broken. In instances, the sealing member (optionally the resiliently deformable mating member) and the resiliently deformable member flex to allow the seal to be broken when the rolling shutter door moves from the closed position to the open position.

Door assemblies according to the present invention may comprise one or more additional seals in addition to the sealing assemblies according to the present invention.

Preferably, the rolling shutter door may comprise a plurality of laths, wherein one or more of the laths comprises a cavity. Optionally the cavity may be at least partially filled with an insulating material, preferably an acoustically insulating material. Advantageously, laths comprising cavities can provide insulation to the rolling shutter door assembly, thus further improving the performance of the rolling shutter door assembly.

Preferably, the door assembly may further comprise: a first guide member and a second guide member for guiding the rolling shutter door between the open position and the closed position; and a barrel positioned between the guides for supporting the rolling shutter door, the barrel being configured to rotate and receive more of the rolling shutter door when said door is rolled to an open position.

The opening may be defined by two opposing side walls, a top wall and an opposing bottom wall. The first guide member and the second guide member may be positioned (i) relative to the opposing side walls; or (ii) relative to the opposing top and bottom walls; to guide the rolling shutter door.

Preferably, at least one of the first guide member and the second guide member may comprise one or more guide sealing members, wherein the one or more guide sealing members may contact the rolling shutter door when in the closed position. Guide members may comprise regions that could allow smoke, heat, sound and the like to travel, in particular in areas that provide a track in which the rolling shutter door is received. Guide sealing members are advantageously provided to provide further insulation, preferably acoustic insulation, to the guide members, thus further improving the performance of the rolling shutter door assembly.

Preferably, at least one of the first guide member and the second guide member may comprise a reversibly attachable bracket. Advantageously, this allows the user of the rolling shutter door assembly to remove the reversibly attachable bracket to access the rolling shutter door, and if desired, to remove the rolling shutter door.

Preferably, at least one of the first guide member and the second guide member may comprise a cavity, optionally wherein the cavity may be at least partially filled with an insulating material, preferably an acoustically insulating material. Advantageously, providing a cavity, which can be filled with an insulating material in the guide members, further improves the performance of the rolling shutter door assembly. Preferably, at least one of the first guide member and the second guide member comprising the cavity may further be provided with one or more perforations, wherein the one or more perforations are positioned to provide a route through which sound and/or heat can travel from an external surface of the guide member into the cavity. Advantageously, where the insulating material is acoustically insulating, sound can thus be adsorbed by the first guide member and/or the second guide member, thus improving the performance of the door assembly. Advantageously, wherein the insulating material is thermally insulating, thermal insulation can thus be provided by the first guide member and/or the second guide member, thus improving the performance of the door assembly.

Preferably, at least one of the first guide member and the second guide member may comprise a recess/channel for receiving the rolling shutter door, wherein the recess has a depth that is from 2 to 20% of the width of the rolling shutter door, optionally from 3 to 15% the width of the rolling shutter door, and optionally still from 5 to 10% the width of the rolling shutter door. Advantageously, providing a recess in at least one of the first guide member and the second guide member provides increased stability of the rolling shutter door against impact (e.g. by a user, or due to wind on the external surface of the rolling shutter door), and moreover improves the thermal and acoustic performance of the door assembly. The recess of channel may be dimensioned to allow the rolling shutter door to flex when in the closed position.

Preferably, the bottom rail of the rolling shutter door may comprise a cavity, optionally wherein the cavity may be at least partially filled with an insulating material, preferably an acoustically insulating material.

Preferably, the bottom rail of the rolling shutter door may comprise a seal positioned on the underside of the bottom rail (i.e. the surface facing the floor during use) to provide a seal between the floor and the rolling shutter door when in the closed position. The seal is preferably resiliently deformable. The seal therefore advantageously prevents passage of sound, heat, smoke and the like from one side of the rolling shutter door to the other, thus improving the performance of the rolling shutter door. Preferably, the bottom rail is further provided with at least one lip, which protrudes from the bottom rail and extends downwardly towards the floor to protect the seal from impact (e.g. impact from a user) and/or to protect the seal from being squashed by the weight of the door. Preferably, the at least one bottom lip protrudes downwardly such that the seal contacts the floor (when the rolling door is in the closed position) before the at least one lip. The seal thus deforms to provide a seal with the floor surface, and the at least one lip then contacts the floor surface to support the rolling door and to prevent the seal from being squashed by the weight of the door. Preferably, the bottom rail comprises two lips, the first lip being positioned on a surface of the bottom rail which faces internally (i.e. the interior of the building during use), and the second lip being positioned on a surface of the bottom rail which faces externally (i.e. the exterior of the building during use). The at least one lip may advantageously provide additional support to the base of the rolling shutter door when in the closed position to prevent unwanted compression of the seal. The guide members, support brackets, and barrel provided in door assemblies in accordance with the present invention may be made of any suitable material. One or more of the guide members and barrel may comprise one or more materials selected from the group consisting of metals and metal alloys (e.g. Steel, aluminium), wood, plastics, and the like.

According to a second aspect of the present invention, there is provided a method of sealing a gap between a rolling shutter door of a door assembly and an opening in a building to which the door assembly is installed, wherein the rolling shutter door is moveable between a closed position wherein the opening is occluded by the rolling shutter door, and an open position wherein the opening is at least partially clear of occlusion by the rolling shutter door, the method comprising:

providing a resiliently deformable member;

providing a sealing member;

positioning each of the resiliently deformable member and the sealing member relative to one, or the other, of the door assembly and the opening in the building; such that the resiliently deformable member co-operates with the sealing member when the rolling shutter door is in a closed position to seal the gap.

Preferably, the method may further comprise positioning the resiliently deformable member on the rolling shutter door of the door assembly; and positioning the sealing member on a wall of the building proximal the opening.

The resiliently deformable member and sealing member in accordance with the second aspect of the present invention may be in accordance with the resiliently deformable members and sealing members described with respect to the first aspect of the present invention.

According to a third aspect of the present invention, there is provided a sealing member for providing a seal in a door assembly, the door assembly being installed to an opening in a building, and comprising a rolling shutter door moveable between a closed position wherein the opening is occluded by the rolling shutter door, and an open position wherein the opening is at least partially clear of occlusion by the rolling shutter door. The sealing member comprises a resiliently deformable mating member; a support frame, for supporting the resiliently deformable member; and means for fixing the sealing member to a wall of the building defining the opening.

Preferably, the sealing member comprises a cavity, optionally wherein the cavity may be at least partially filled with an insulating material, preferably an acoustically insulating material. Advantageously, the sealing member may be provided with additional insulation, which can further improve the performance of the rolling shutter door assembly.

Optionally, the sealing member comprises a cavity, wherein the cavity is at least partially filled with a resiliently deformable insulating material. Advantageously, the resiliently deformable insulating material may urge the resiliently deformable mating member from a mating configuration into a resting configuration.

The sealing member in accordance with the third aspect of the present invention may be in accordance with the sealing member described with respect to the second aspect of the present invention.

According to a fourth aspect of the present invention, there is provided a sealing assembly kit for providing a seal to a door assembly, the door assembly being installed to an opening in a building, and comprising a rolling shutter door moveable between a closed position wherein the opening is occluded by the rolling shutter door, and an open position wherein the opening is at least partially clear of occlusion by the rolling shutter door. The sealing assembly kit comprises a sealing member according to the first or third aspect of the present invention; and a resiliently deformable member according to the first aspect of the present invention, configured to be positioned on an exterior surface of the rolling shutter door.

Door assemblies according to the present invention may be used in one or more of commercial, industrial, public, and domestic buildings. Door assemblies of the invention may be provided for one or more of security purposes, fire prevention or fire retardation, thermal insulation (e.g. refrigerators and/or freezers), and acoustic insulation (e.g. theatre doors, cinema doors, music studio doors, television and film production set doors).

In embodiments, it may be desirable to provide a door assembly that is insulated e.g. thermally insulated, acoustically insulated. In embodiments, it may be desirable to provide a door assembly that is acoustically insulated, that is to say the door assembly is configured to absorb noise emanating from one side of the door, and to reduce transmission of said noise to the other side of the door. It embodiments, it may even be desirable to substantially prevent transmission of said noise from one side of the door assembly. Door assemblies that are acoustically insulated according to the present invention may be particularly desirable in commercial, industrial and public buildings such as, but not limited to, factories, theatres, music studios, cinemas, television and film production sets and the like. For example, it may be desirable to reduce noise emanating from machinery in factories or industrial sites (e.g. water treatment sites, waste treatment sites), which could cause a nuisance to residential areas.

Door assemblies according to the present invention are for an opening in a building. The opening allows passage from the exterior of a building into the interior of the building, or visa versa. The opening may provide passage for one or more persons, vehicles, and the like. As such, the opening in the building may be of any suitable dimensions, and the door assemblies according to the present invention may be configured to complement the size of said opening.

The opening may be defined by two opposing side walls, a top wall and a bottom wall opposing the top wall. Within the context of the present invention, in embodiments, the bottom wall may be the ground. In buildings suitable for use in accordance with the present invention, one or more of the top wall, bottom wall and side walls may be constructed of one or more of brick, concrete, breeze blocks, wood, steel, and the like.

Door assemblies according to the present invention are installable to an opening in a building. In embodiments, door assemblies according to the present invention may be installed in the opening. Those skilled in the art will understand in the opening to mean the door assembly is installed within the opening that is defined by one or more of the top wall, bottom wall and side walls (e.g. in the manner of a conventional internal door frame). In alternative embodiments, the door assemblies according to the present invention may be installed around the opening. Those skilled in the art will understand around the opening to mean the door assembly is installed on either an internal or external surface of the building at one or more of the top wall, bottom wall, and side walls defining the opening.

Door assemblies according to the present invention comprise a rolling shutter door. The rolling shutter door has a closed position wherein the opening is occluded by the rolling door, and an open position wherein the opening is at least partially clear of occlusion by the rolling shutter door. Rolling shutter doors are well known to those skilled in the art, and typically may be rolled up into a coil. Rolling shutter doors within the context of the present invention are therefore flexible doors.

In embodiments, rolling shutter door may be provided in the form of one or more curtains (not illustrated). Each curtain may be comprised of one or more interlocking laths; or may be of continuous construction. In embodiments, the rolling shutter door comprises two curtains positioned in an overlying formation, such that a cavity is provided between each curtain (not illustrated). The cavity may be at least partially filled with an insulating material to improve the performance of the rolling shutter door. For example, the rolling shutter door may be for the purposes of acoustic insulation, and an acoustically insulating material such as Rockwool® and/or mineral wool may be provided in the cavity. Further examples of suitable materials for at least partially filling the cavity may include thermally insulating materials (e.g. Rockwool®, mineral wool, polystyrene, polyurethane foam, and combinations thereof), fire retardant materials (e.g. Rockwool®, and/or mineral wool), and the like. Other suitable materials may include for example plaster (e.g. gypsum) and/or calcium silicate (e.g. calcium board).

### LIST OF FIGURES

The present invention will now be described by way of example only, and with reference to the accompanying Figures in which:

FIG. 1 illustrates a rear-side (e.g. interior of a building) elevated view of a prior art door assembly comprising a rolling shutter door in its fully closed position.

FIG. 2 illustrates a rear-side elevated view of the prior art door assembly of FIG. 1 in its fully open position.

FIG. 3 illustrates a rear-side elevated view of the prior art door assembly of FIGS. 1 and 2 in a partially open position, wherein the rolling shutter door partially occludes the door passage.

FIG. 4 illustrates an end view of a barrel and a rolling shutter door comprised in the prior art door assembly of FIGS. 1-3, wherein the rolling shutter door is in its fully open position.

FIG. 5 illustrates an end view of a barrel and a rolling shutter door comprised in the prior art door assembly of FIGS. 1-3, wherein the rolling shutter door is in the closed position.

FIG. 6 illustrates a partial end view of the prior art door assembly of FIGS. 1-5 comprising a prior art sealing assembly.

FIG. 7 illustrates an enlarged view of the prior art sealing assembly illustrated in FIG. 6.

FIG. 8 illustrates a partial end view of a door assembly according to the present invention, wherein the rolling shutter door is in its fully open position, a sealing member is in a resting configuration, and a resiliently deformable member is in a non-sealing configuration.

FIG. 9 illustrates a partial end view of the door assembly illustrated in FIG. 8, wherein the rolling shutter door is its fully closed position, and the resiliently deformable member and sealing member are co-operating to seal the gap.

FIGS. 10, 11 and 12 illustrate side cross-sectional views of a resiliently deformable member comprised in a sealing assembly according to the present invention.

FIG. 13 illustrates a resiliently deformable member in the sealing configuration.

FIG. 14 illustrates a side cross-sectional view of a sealing member comprised in a sealing assembly according to the present invention, wherein the sealing member is in a resting configuration.

FIG. 15 illustrates a side view of a barrel comprised in the door assemblies of FIGS. 1-3, wherein the barrel has the rolling shutter door coiled about itself.

FIG. 16 illustrates a side cross-sectional view of the barrel illustrated in FIG. 15, wherein the rolling shutter door is at least partially uncoiled from the barrel.

FIGS. 17, 18 and 19 illustrate plan cross-sectional views of guide members comprised in a door assembly according to the present invention.

FIG. 20 illustrates a side cross-section view of a bottom rail comprised in a rolling door in accordance with the present invention.

### DETAILED DESCRIPTION

The invention will be now be described in detail with reference to the accompanying Figures. The description of particular embodiments is not intended to be limiting on the scope of the invention, which is defined in the appended claims.

In accordance with the present invention, the term ‘resiliently deformable’ means having a first configuration, which can be induced through application or release of a biasing force, into a second configuration. Upon removal of said biasing force, the second configuration returns to the first configuration. ‘Resiliently deformable’ materials may be flexible, elastic, spongy, and the like. Preferably, ‘resiliently deformable’ as used herein means capable of being repeatedly deformed, without losing structural integrity or performance. For instance, resiliently deformable objects include sponges, foams, elastic bands and the like.

Insulating materials in accordance with the present invention may comprise acoustically insulating materials, thermally insulating materials, fire-retardant materials, and the like. Insulating materials as described herein are selected from an acoustically insulating material, a thermally insulating material, a fire-retardant material, and combinations thereof. Acoustically insulating materials may include Rockwool™, mineral wool, polyurethane foam, rubber, sponge, plaster (e.g. gypsum), composite boarding materials (e.g. plasterboard) and combinations thereof. Preferably, acoustically insulating materials are selected from Rockwool®, mineral wool and combinations thereof. Thermally insulating materials may include Rockwool®, mineral wool, polystyrene, polyurethane foam, rubber, sponge, plaster (e.g. gypsum), composite boarding materials (e.g. plasterboard, insulating boards) and combinations thereof. Preferably, thermally insulating materials are selected from Rockwool®, mineral wool, polystyrene, polyurethane foam, and combinations thereof. Fire retardant materials may include Rockwool™, mineral wool, composite boarding materials (e.g. fire-resistant boards) and combinations thereof. Preferably, fire retardant materials are selected from Rockwool®, mineral wool, and combinations thereof. Other suitable generally insulating materials may include for example plaster (e.g. gypsum) and/or calcium silicate (e.g. calcium board).

Resiliently deformable insulating materials in accordance with the present invention are materials which have both resiliently deformable and insulating properties. Suitable resiliently deformable insulating materials include sponges, foams, fabrics, and the like. Resiliently deformable insulating materials in accordance with the present invention may comprise an acoustically insulating material, a thermally insulating material, a fire-retardant material, and combinations thereof. Resiliently deformable insulating materials in accordance with the present invention be selected from an acoustically insulating material, a thermally insulating material, a fire-retardant material, and combinations thereof. Preferably, the resiliently deformable insulating material is a sponge. Preferably, the resiliently deformable insulating material is a foam.

The term ‘sheet’ in accordance with the invention means a thin, substantially two-dimensional material having a length and or width that is substantially greater than its depth. ‘Sheet’ within the context of the present invention may include a sheet having a thickness from 1 to 10 mm, optionally from 2 to 8 mm, and optionally still from 3 to 6 mm.

Resiliently deformable sheets in accordance with the present invention are resiliently deformable within the meaning described above. Resiliently deformable sheets may be made of suitable flexible textiles (e.g. cloths), rubbers, plastics, elastomeric materials, and optionally combinations thereof. The resiliently deformable sheets in accordance with the present invention may comprise, or consist of polyvinyl chloride. Resiliently deformable sheets in accordance with the present invention may have a thickness from 1 to 10 mm, optionally from 2 to 8 mm, optionally still from 3 to 6 mm (e.g. around 4 mm, around 5 mm). Resiliently deformable sheets in accordance with the present invention may comprise, or consist of polyester reinforced polyvinyl chloride. Resiliently deformable sheets in accordance with the present invention may be a polyester reinforced polyvinyl chloride sheet, wherein the polyester reinforced polyvinyl chloride sheet may has a thickness from 2 to 5 mm (e.g. around 3 mm, around 4 mm). Suitable examples of polyester reinforced polyvinyl chloride include TARPOL™ sheets, e.g. TARPOL™ TS 700 commercially available from Gale Pacific (www.galpacific.com).

It will be apparent to those skilled in the art that resiliently deformable sheets in accordance with the present invention may be selected according to the desired flexibility and deformability by changing the thickness thereof and/or by selecting suitable materials. For example, those skilled in the art will appreciate that polyester reinforced polyvinylchloride (e.g. Tarpol™) is more flexible than polyvinylchloride sheets.

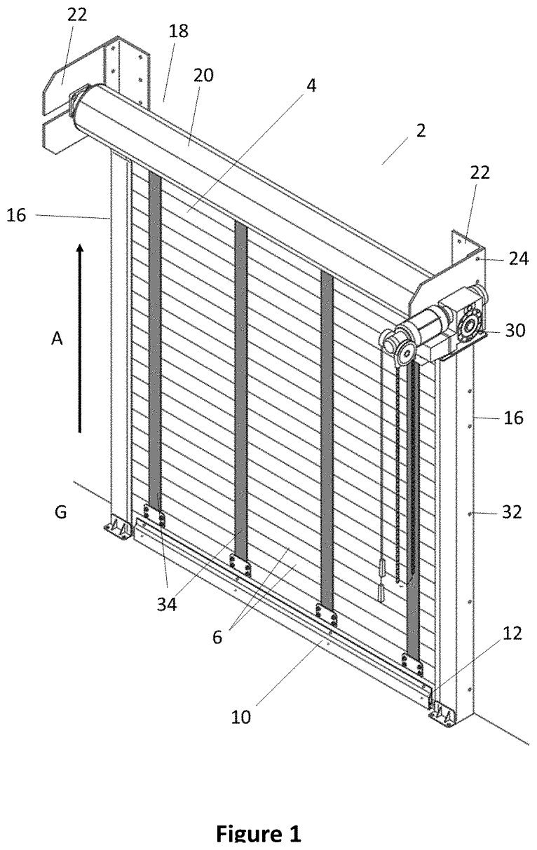

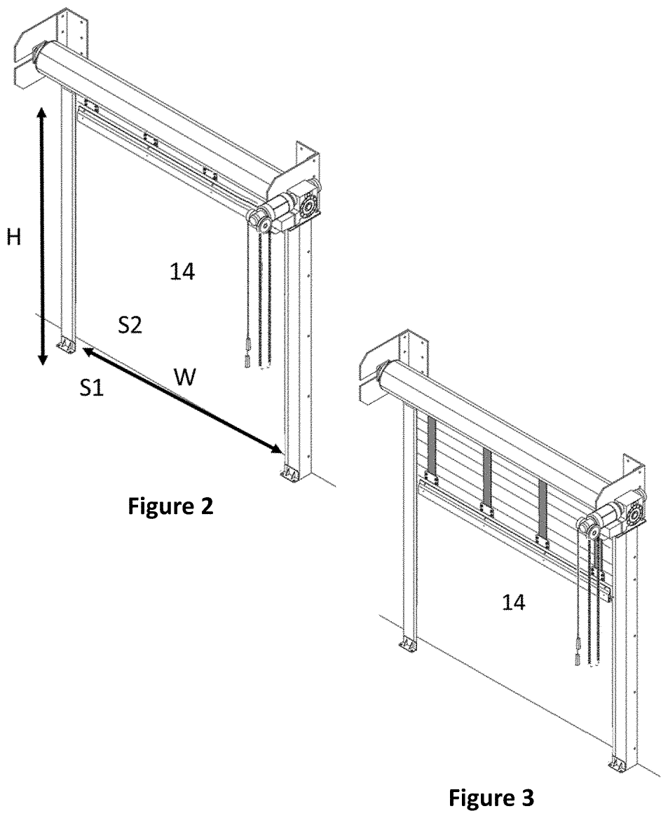

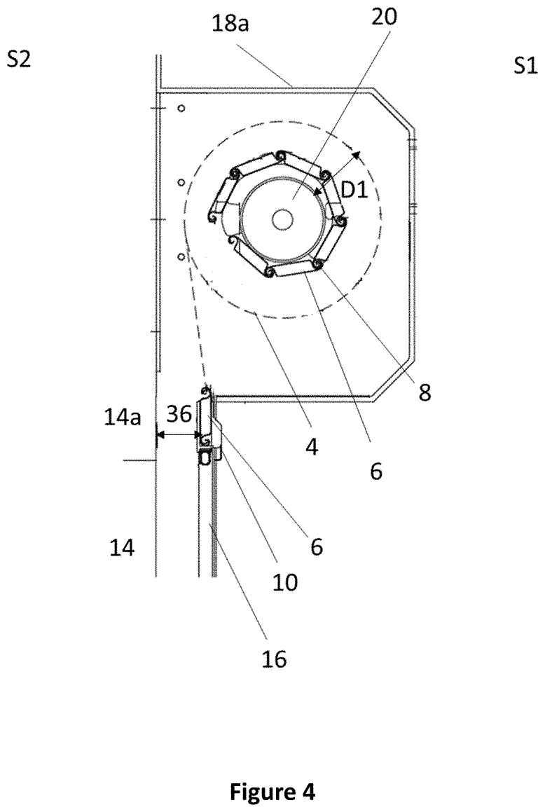

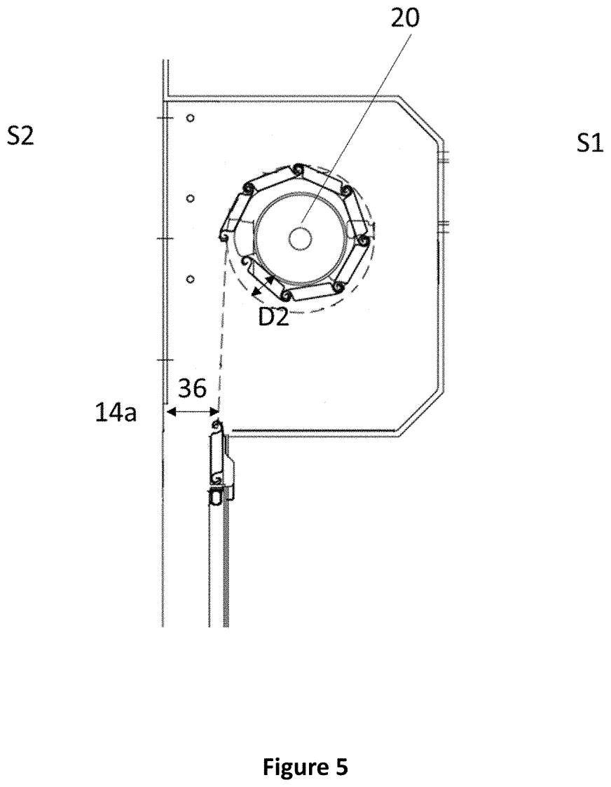

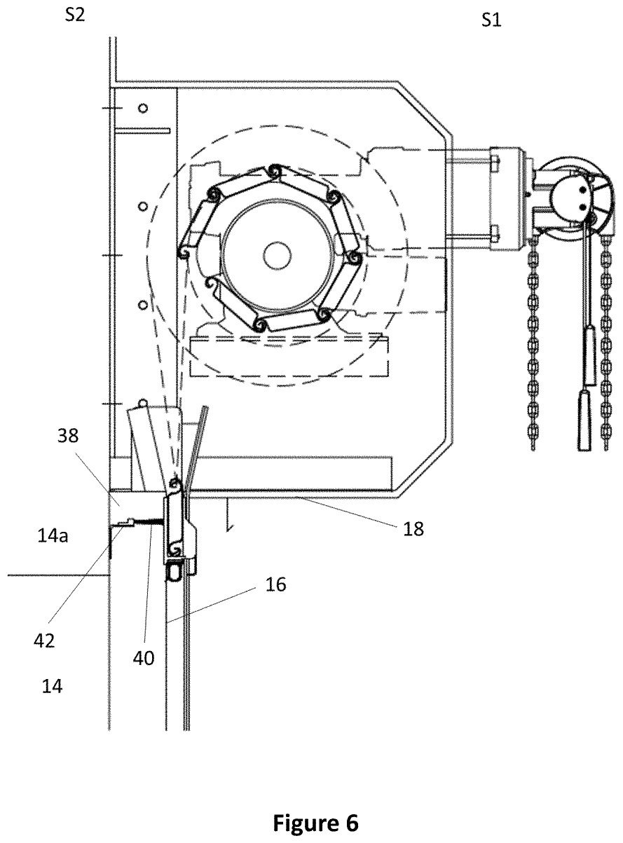

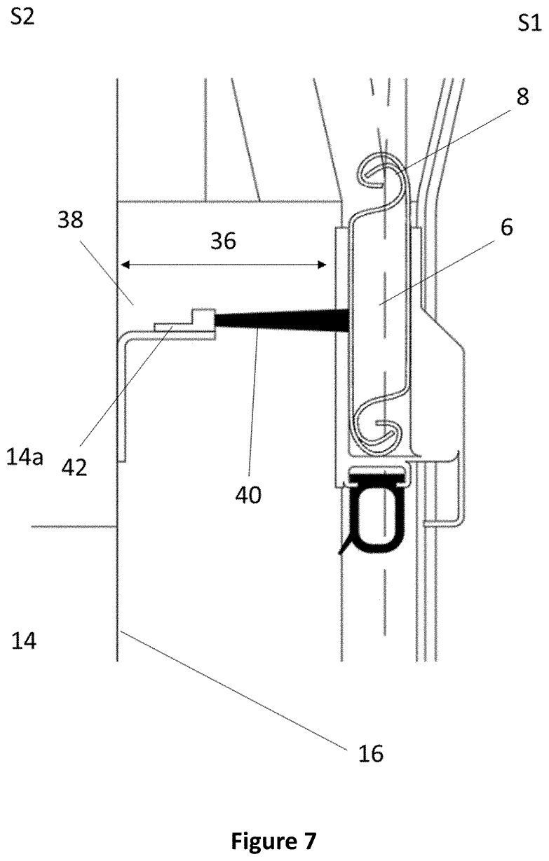

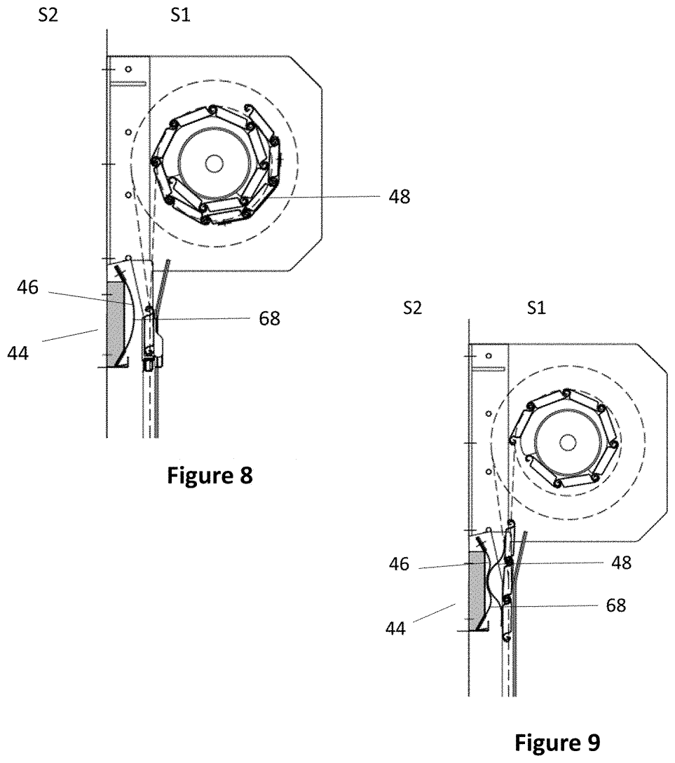

FIGS. 8 and 9 illustrate a partial door assembly in accordance with the present invention wherein the rolling shutter door 4 is in its open position and its closed position respectively. The door assembly of the present invention shares many features of a known door assembly, such as that described above and illustrated in FIGS. 1-5, and as such those features may be described below as needed for context with the same reference numerals as used in FIGS. 1-5. However, the present invention also includes a number of inventive features, which will be described below.

The door assembly of the invention comprises, in addition to a rolling shutter door 4, a sealing assembly 44 comprising a sealing member 46 and a resiliently deformable member 48. The resiliently deformable member 48 and sealing member 46 are each mutually positioned such that the resiliently deformable member 48 co-operates with the sealing member 46 when the rolling shutter door 4 is in the closed position to seal the gap 36, as can be seen in FIG. 9.

The resiliently deformable member 48 is provided on an upper portion of the rolling shutter door 4. With reference the FIG. 8, the resiliently deformable member 48 (illustrated by the thickened black line) is co-rolled (i.e. coiled) with barrel 20. The dashed lines in FIG. 8 illustrate the size of the coil of rolling shutter door when fully coiled around the barrel 20.

As shown in FIG. 9, the resiliently deformable member 48 is positioned at an upper portion of the rolling shutter door 4 to seal the gap 36; and the sealing member 36 is mutually positioned to co-operate with the resiliently deformable member 48. The sealing member 46 is positioned above and adjacent to the opening 14, for example, the top wall defining the opening of a building.

With reference to FIG. 8, when the rolling shutter door 4 is in an open position (wherein the rolling shutter door 4 is at least partially coiled about the barrel 20) the resiliently deformable member 48 (represented by the thick black line in FIG. 8) has a non-sealing configuration. The non-sealing configuration of the resiliently deformable member 48 complements the configuration of the rolling shutter door 4, more particularly, complements the arcuate conformation of the rolling shutter door 4 when coiled about the barrel 20. The resiliently deformable member 48 shown in FIG. 8 lies substantially flush with a surface of the rolling shutter door 4. In the non-sealing configuration, the resiliently deformable member 48 spans at least part of the circumference of an arcuate portion of the rolling shutter door 4, when the rolling shutter door 4 is provided in a coiled configuration about barrel 20.

When the rolling shutter door 4 is in the closed position, the rolling shutter door 4 is uncoiled from the barrel 20, and the resiliently deformable member 48 has a sealing configuration. With reference to the embodiment illustrated in FIG. 9, the sealing configuration of the resiliently deformable member 48 protrudes from the surface of the rolling shutter door in the form of a bulb.

In the sealing configuration, the resiliently deformable member 48 co-operates with the sealing member 46. The resiliently deformable member 48 and the sealing member 46 have complementary configurations when the rolling shutter door 4 is in the closed position to provide the seal, as illustrated in FIG. 9. As discussed in more detail below, the complementary shapes arise from an induced fit, wherein the resiliently deformable member 48 in the sealing configuration induces a complementary shape in the sealing member 46. As such, the resiliently deformable member 48 and the sealing member 46 have interlocking configurations to provide an effective seal.

The sealing member 46 has a mating configuration as illustrated in FIG. 9; and a resting configuration as illustrated in FIG. 8. As shown in FIG. 8, the sealing member 46 has a resting configuration when the rolling shutter door 4 is in an open position wherein the sealing member 46 protrudes outwardly into the gap 36 towards the interior S1 of the building. The sealing member 46 also has a mating configuration when the rolling shutter door is in the closed position, which is complementary to the sealing configuration of the resiliently deformable member 48. The sealing member 46 is deformed by the resiliently deformable member 48 (when in the sealing configuration) into a corresponding reciprocal shape, as shown in FIG. 9 (discussed in further detail below).

The sealing member 46 is mutually positioned relative to the resiliently deformable member to co-operate when the rolling shutter door 4 is in the closed position. The sealing member 46 is positioned such that it is in a complementary position to contact the resiliently deformable member 48 when the rolling shutter door 4 is in the closed position, as illustrated in FIG. 9.

FIG. 9 illustrates the sealing assembly 44 shown in FIG. 8, with the exception that the rolling shutter door 4 is provided in a closed position. When the rolling shutter door 4 is in the closed position, the resiliently deformable member 48 contacts and co-operates with the sealing member 46 to provide a seal. The resiliently deformable member 48 is affixed to the rolling shutter door 4, such that when the rolling shutter door 4 is in the closed position, the resiliently deformable member 48 protrudes away from the rolling shutter door 4, as illustrated in FIG. 9. The resiliently deformable member 48 is urged away from the rolling shutter door 4 to protrude therefrom by virtue of the rolling shutter door 4 moving from an arcuate configuration to a planar configuration.

The resiliently deformable member 48 in the sealing configuration induces the sealing member 46 to adopt a complementary mating configuration, as illustrated by the change of configuration of the sealing member 46 between FIG. 8 and FIG. 9. In the sealing configuration, the resiliently deformable member 48 abuts the sealing member 46 causing it to deform inwardly from the resting configuration to the mating configuration. The resiliently deformable member 48 thus creates a recess in the sealing member 46, in which resiliently deformable member 48 rests. Advantageously, this arrangement allows a secure and tight seal to be formed across the gap 36. Preferably, the sealing member 46 comprises a more flexible material than the resiliently deformable member 48, such that the sealing member 46 is deformed by the resiliently deformable member 48 (in the sealing configuration) from the resting configuration into the mating configuration.

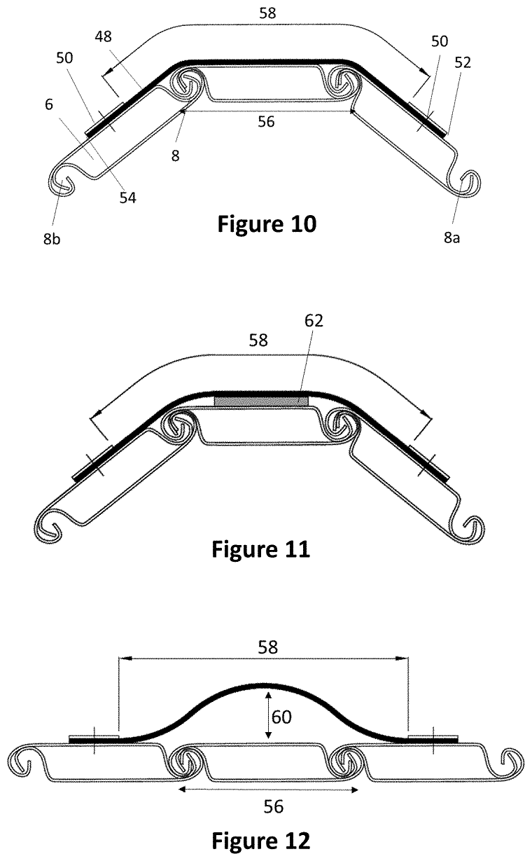

FIGS. 10 to 12 illustrate a resiliently deformable member 48 comprised in a sealing assembly 44 of the door assembly of the present invention in sealing (FIG. 12) and non-sealing (FIGS. 10 and 11) configurations.

FIGS. 10 and 11 illustrate the resiliently deformable member 48 wherein the laths 6 of the rolling shutter door 4 are in an arcuate configuration, as would be the case when the rolling shutter door is in an open position being rolled around the barrel 20.

With reference to FIG. 10, the resiliently deformable member 48 is attached to the rolling shutter door 4 at one or more laths 6 by attachment means 50. The resiliently deformable member 48 is attached to the rolling shutter door at portions that are proximal the outer perimeter of the resiliently deformable member 48, as shown in FIG. 10. More particularly, the resiliently deformable member 48 is affixed to rolling shutter door 4 at an upper edge 52 of the resiliently deformable member 48, and at a lower edge 54 of the resiliently deformable member 48. A central portion 58 of the resiliently deformable member 48 is free of the rolling shutter door 4, that is to say the central portion 58 is not affixed to the rolling shutter door 4. The central portion 58 being free of the rolling shutter door 58 allows the resiliently deformable member 48 to move freely between the sealing and non-sealing configurations, as discussed in more detail below with reference to FIG. 12.

FIG. 10 additionally depicts a magnified view of a plurality of laths 6 comprised in a rolling door 4 in accordance with the present invention, and interlocking members 8 as previously discussed in respect of FIGS. 1-5. The interlocking members have complementary shapes, such that an interlocking member 8a of a lath may interlock with an interlocking member 8b of another lath 6. For example, the interlocking members 8 may be ‘snap-fit’ interlocking members. The interlocking members 8 enable adjacent laths to pivot with respect to one another.

Although FIG. 10 illustrates the resiliently deformable member 48 and rolling shutter door 4 in cross-section, those skilled in the art will appreciate that the resiliently deformable member 48 may be secured by attachment means 50 at multiple cross-sections. That is to say the attachment means 50 may be provided at a plurality of cross-sections along the width of the rolling shutter door 4. The attachment means 50 may even extend substantially continuously across the width of the resiliently deformable member, for example, where the attachment means is an adhesive.

Attachment means 50 may be any suitable means for attaching the resiliently deformable member to the rolling shutter door 4, for example, an adhesive, screws, nails, rivets, bolts and nuts, or a combination thereof.

FIG. 11 illustrates the resiliently deformable member 48 of FIG. 10, with the exception that protecting member 62 is additionally provided. The protecting member 62 is provided to mitigate strain on the resiliently deformable member 48 when in the non-sealing configuration. For example, the protecting member 62 may be a resiliently deformable material (e.g. sponge, foam) to cushion the resiliently deformable member 48 against the laths 6 of the rolling shutter door 4.

FIG. 12 illustrates the resiliently deformable member 48 in a sealing configuration, wherein the laths 6 of the rolling shutter door 4 are in a planar configuration, as would be the case when the rolling shutter door is in a closed position. In contrast to the non-sealing configuration of the resiliently deformable member 48 illustrated in FIGS. 10 and 11, in the sealing configuration illustrated in FIG. 12, the resiliently deformable member 48 protrudes away from the rolling shutter door 4. More particularly, the central portion 58 of the resiliently deformable member protrudes away from laths 6 of the rolling shutter door 4. The protrusion of the central portion 58 resembles a bulb, as also illustrated in FIG. 9.

As the rolling shutter door 4 moves from an arcuate configuration when coiled about barrel 20, as illustrated in FIGS. 10, 11, to a planar configuration as the rolling shutter door is dispensed from the barrel, as illustrated in FIG. 12, the distance between two notional points on the rolling shutter door decreases. For example, the distance between each attachment means 50 in FIG. 10 is less than the distance between each attachment means 50 in FIG. 12. In other words, the circumference of an arcuate portion of the rolling shutter door when coiled about the barrel is greater than the length of the rolling shutter door when in a planar configuration. This reduction in length causes the resiliently deformable member 48 to be urged away from laths 6 of the rolling shutter door 4 to form a protrusion, as illustrated in FIG. 12.

The distance 60 by which the resiliently deformable member 48 protrudes is determined by the length of the resiliently deformable member 48 and/or the distance between the attachment means 50 at which the resiliently deformable member 48 is attached to the rolling shutter door 4. The distance between attachment means 50 may be from 1 to 5 times the width 56 of a lath 6, optionally 1.5 to 3 times the width 56 of a lath 6, and optionally still around 2 times the with 56 of a lath 6.

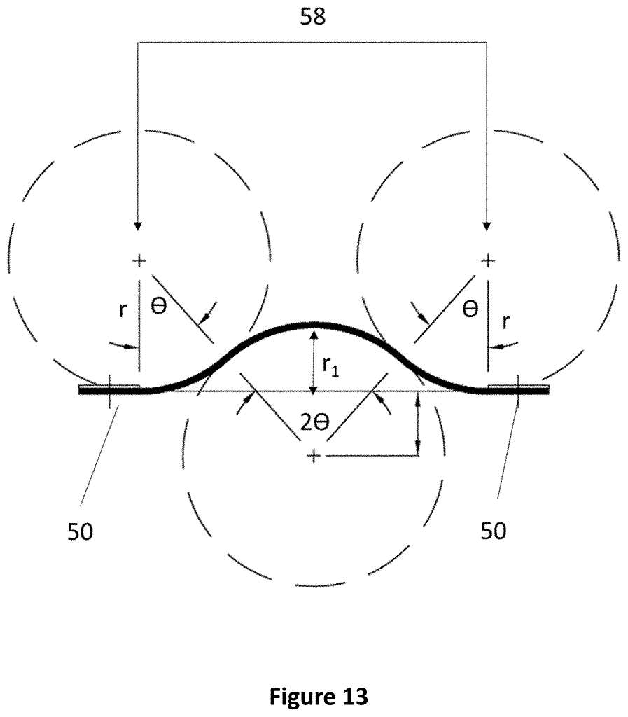

With reference to FIG. 13, the distance 60 (indicated as r₁ in FIG. 13) which the resiliently deformable member 48 protrudes may be calculated by consideration of distance r₁ and a plurality of notional circles, wherein the circumference of said notional circles are in tangential contact (i.e. at a single point). As shown in FIG. 13, the profile of the protruding resiliently deformable member 48 may resemble a bell curve. The desired distance 60 may be adjusted by considering the relationship between the length of central portion 58 and the arc length of angles as illustrated in FIG. 13. The length of the bell curve shape formed by central portion 58 is approximately half that of the length of the inverse side of the bell shape i.e. the bell curve length is 2⁻πr(θ/360) where θ is the angle across which the central portion 58 extends. The extent of the distance r₁ as shown in FIG. 13, can be calculated using the following equation: r₁=2 (r−(r cos θ)) where r is the radius of the notional circle and e is the angle across which the central portion 58 extends.

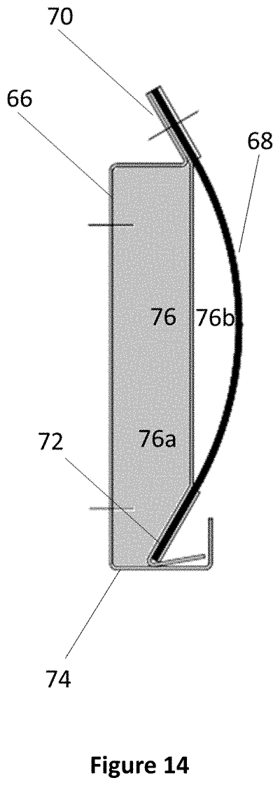

FIG. 14 (providing a detailed view of the sealing member illustrated in FIGS. 8 and 9) illustrates a sealing member 46 comprised in a sealing assembly 44 in accordance the present invention. The sealing member 46 is configured to co-operate with the resiliently deformable member 48 when the rolling shutter door 4 is in the closed position to provide a seal across the gap 36.

The sealing member 46 comprises a mating member 68, which is positioned to contact the resiliently deformable member 48 when the rolling shutter door 4 is in the closed position to provide a seal. As such, the mating member 68 co-operates with the resiliently deformable member 48 to provide a seal. The mating member 68 has the resting configuration (as shown in FIG. 14) when the rolling shutter door 4 is in the open position, and the mating configuration when the rolling shutter door 4 is in a closed position, as discussed above with respect to the sealing member 46.

The sealing member 46 may be a resiliently deformable sealing member. With reference to FIG. 14, the mating member 68 comprised in the sealing member 46 is resiliently deformable to provide a resiliently deformable mating member 68. The resiliently deformable mating member 68 is flexible, such that when the resiliently deformable member 48 makes contact with the mating member 68 to form the seal 44, the mating member 68 is induced into a shape that is complementary to the sealing configuration of the resiliently deformable member 48. As such, the resiliently deformable member 48 in the sealing configuration induces the mating member 68 into a corresponding, complementary mating configuration. This arrangement advantageously improves the efficacy of the sealing assembly 44 by virtue of the complementary configurations of the resiliently deformable member 48 and the mating member 68, as illustrated in FIG. 9. In this arrangement, the mating member 68 is more flexible that the resiliently deformable mating member 48, thus allowing the resiliently deformable member 48 in the sealing configuration to induce the mating member 68 to adopt the mating configuration (FIG. 9).

With reference to FIG. 14, the sealing member 46 further comprises a support frame 66. The mating member 68 is secured to the support frame 66. The support frame 66 comprises one or more lips 70 for receiving a portion of the mating member 68. The support frame 66 further comprises one or more receiving channels 72 into which the mating member 68 may be inserted and secured thereto. The mating member 68 is secured to the lip 70 and/or in the receiving channel 72 by any suitable means, for example adhesive, screws, nails, bolts, rivets and the like.

The receiving channel 72 is slidably moveable relative to the base 74 of the support 66. Those skilled in the art will appreciate that this is just one-way of achieving the arrangement described further with reference to FIG. 14, and other ways of achieving the arrangement will be apparent to those skilled in the art. As shown in FIG. 14, the channel 72 is disassociated from the rest of the body of the support 66, for example having an L configuration that rests against the base 74. As such, the channel 72 is moveable with respect to the base 74 of the support 66. In use, as the resiliently deformable member 48 contacts the sealing member to co-operate and form a seal, this arrangement provides additional flexibility in the position of the mating member 68 when the resiliently deformable member is in the sealing configuration.

The sealing member 46 further comprises a cavity 76 (FIG. 14). The cavity 76 may be at least partially filled with an insulating material, for example a thermally insulating material and/or an acoustically insulating material. Preferably, the cavity 76 is at least partially filled with an acoustically insulating material. The cavity may comprise a chamber 76a, which is comprised in the support 66, and a natural cavity 76b defined by a void between the support and the mating member 68.

Alternatively, a mating member 68 comprised in the sealing member 46 may be directly affixed to a wall (e.g. an upper wall above the opening) in a building (in the absence of the support frame 66), to create a cavity between the wall and the mating member 68 (not illustrated). The cavity may be at least partially filled with an insulating material, for example a thermally insulating material or an acoustically insulating material. Preferably, the cavity is at least partially filled with an acoustically insulating material.

The cavity 76 of the support 66 as illustrated in FIG. 14 and as described above may be at least partially filled with a resiliently deformable insulating material. Alternatively, the cavity between the wall and the mating member 68 as described above may be at least partially filled with a resiliently deformable insulating material. The resiliently deformable insulating material is flexible, and is capable of being deformed into a mating configuration upon application of a force, and of returning to its original, resting configuration when the force is removed (e.g. a sponge).

The resiliently deformable insulating material may provide support to the resiliently deformable mating member 68, such that the mating member 68 is biased to a resting, non-sealing configuration, as shown in FIG. 14. Preferably, the cavity 76 is substantially filled with a resiliently deformable insulating material. As such, when the resiliently deformable member 48 contacts the mating member 68 to form the seal 44, and induces the mating member 68 into the mating configuration, the resiliently deformable insulating material also deforms through contact with the mating member 68. When the seal 44 is broken (i.e. when the rolling shutter door is moved from the closed position to the open position), the resiliently deformable insulating material returns to its non-deformed, resting configuration, and thus may induce the mating member 68 to return to the non-sealing, resting configuration (FIG. 14) from the complimentary mating configuration.

Where the resiliently deformable insulating material is provided in the cavity 76 or in the cavity between the wall and the mating member as described above, the resiliently deformable mating member 68 may comprise or consist of a resiliently deformable sheet. Preferably the resiliently deformable sheet is a polyester reinforced polyvinyl chloride sheet. Suitable examples of polyester reinforced polyvinyl chloride include TARPOL™ sheets, e.g. TARPOL™ TS 700 commercially available from Gale Pacific (www.galepacific.com).

Alternatively, the cavity 76, or cavity between the wall and the mating member 68, as described above is vacant. Where the cavity 76, or the cavity between the wall and the mating member as described above are vacant, the resiliently deformable mating member 68 may comprise or consist of plastic material, such as polyvinyl chloride. Preferably, the mating member 68 is a polyvinyl chloride sheet.

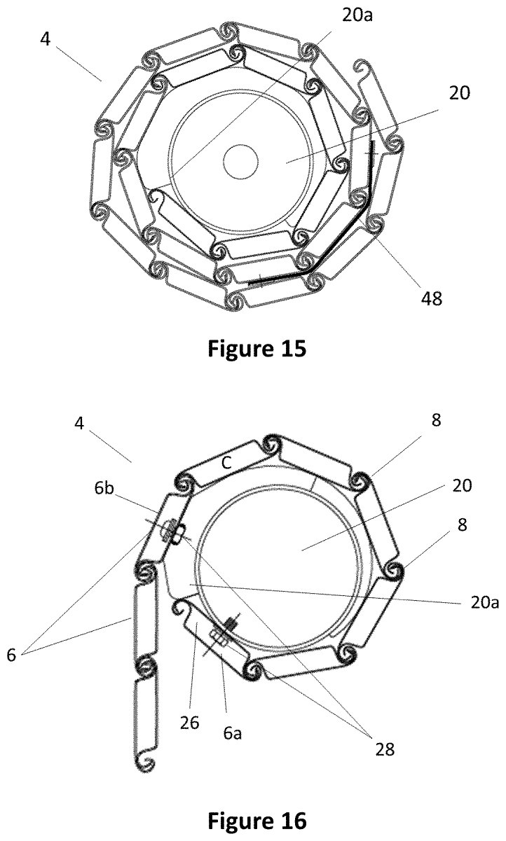

FIG. 15 illustrates a side-on view of the barrel 20 depicted in prior art FIGS. 1-3 wherein the rolling shutter door 4 is coiled around the barrel 20, such that the rolling shutter door 4 is in an open position. A resiliently deformable member 48, comprised in the sealing assembly 44 according to the present invention, is provided in a non-sealing configuration as described above. The resiliently deformable member 48 complements the configuration of the rolling shutter door 4 in its coiled configuration about the barrel 20. The resiliently deformable member 48 may lie substantially flush with a surface of the rolling shutter door 4, wherein the surface may face the interior of a building S1, or the exterior of a building S2 when the rolling door 4 is in the closed position.

FIG. 16 illustrates the same barrel 20 as depicted in FIG. 15, wherein the rolling shutter door 4 has been at least partially uncoiled from the barrel 20. The rolling shutter door 4 comprises a plurality of laths 6, and one or more of the plurality of laths 6 may comprise a cavity C. The cavity C may be at least partially filled with an insulating material to improve the performance (e.g. the acoustic performance and/or the thermal performance and/or the fire performance) of the rolling shutter door 4. For example, the rolling shutter door 4 may be an acoustically insulating door, and an acoustically insulating material may be provided to at least partially fill the cavity C. Further examples of suitable materials for at least partially filling the cavity C may include thermally insulating materials, fire retardant materials, and the like.

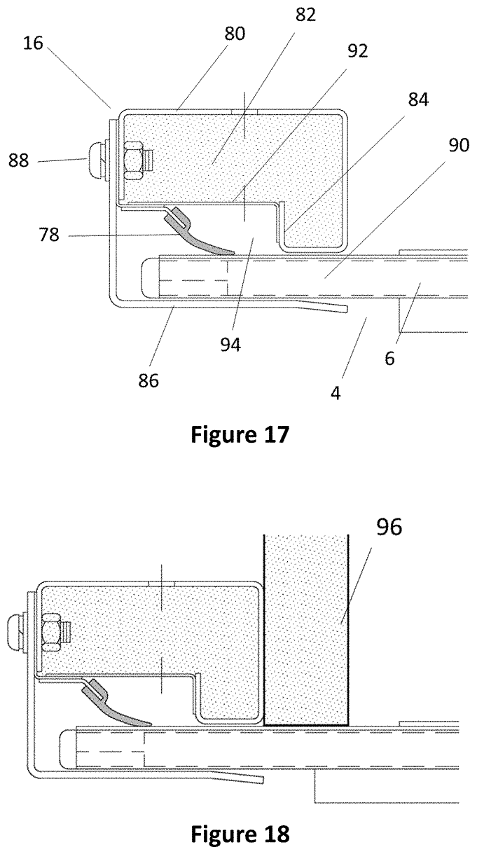

The guide members 16 may comprise a channel 90 for receiving laths 6 of the rolling shutter door 4. FIG. 17 illustrates a plan view of a guide member 16 that can be incorporated into door assemblies according to the present invention. A channel 90 is provided into which the rolling shutter door 4 is received, and preferably secured in position. The channel 90 is defined between a body portion 80 of the guide member and a portion 86 extending therefrom to create a cavity 94 into which the rolling shutter door 4 may be received. Of course, the channel 90 needs to be of sufficient width to allow the rolling shutter door 4 to move freely between the open and closed positions. As such, the channel 90 acts as a track in which the rolling shutter door 4 is received and guided between the open and closed positions.

With continued reference to FIG. 17, the guide members 16 may comprise a reversibly attachable bracket 86 to allow easy installation and removal of rolling shutter door 4, as shown in FIG. 17. The reversibly attachable bracket 86 is reversibly attached to a body portion 80 of the guide member 16. Suitable means for attaching the reversibly attachable bracket 86 to the body portion 80 may include, for example, bolts 88 and nuts as illustrated in FIG. 17, screws, nails, and the like. Advantageously, the reversibly attachable bracket 86 can be removed to access the rolling shutter door 4, for example to remove the rolling shutter door 4 for maintenance.

The guide members comprise a body portion 80 that is at least partially hollow. As illustrated in FIG. 17, the body portion 80 is at least partially filled with an insulating material 82, for example a thermally insulating material or an acoustically insulating material. Preferably, the body portion 80 is at least partially filled with an acoustically insulating material. Providing an insulating material in the body portion 80 of guide members 16 provides further improvement to the performance of the door assemblies by mitigating the transfer of noise, smoke, heat, and the like from one side S1 of the door assembly, to another S2.

The body portion 80 further comprises a lip portion 84, as illustrated in FIG. 17. The lip portion 84 and portion 86 (e.g. reversibly attachable bracket 86) collectively define part of the channel 90 into which the rolling shutter door 4 is received. The lip portion 84 increases the size of the cavity 94 into which the rolling shutter door 4 is received. This increase in the size of the cavity 94 provides a region (cavity 94) in which the passage of smoke, sound, heat and the like may blocked and subsequently adsorbed by the guide member. For example, as illustrated in FIG. 17, the guide members 16 are provided with a guide seal member 78 that extends across the cavity 94 from the body portion 80 to contact the rolling shutter door 4, thus providing a seal and improving the performance of the door assembly. The guide seal member 78 may be an acoustically insulating guide seal member 78, wherein the acoustically insulating guide seal member 78 is made of an acoustically insulating material. Moreover, a section 92 of the body portion 80 which defines cavity 94 may be provided with one or more perforations (not illustrated). The one or more perforations may allow for access (for example access for sound waves, thermal energy, smoke) to the insulating material 82 within the body portion 80 to improve the performance of the door assembly.

Guide members 16 may further comprise a baffle member 96 to further restrict or prevent travel of sound, fire, smoke, heat and the like, as illustrated in FIG. 18. The baffle member 96 may be an acoustic baffle member 96. In FIG. 18, the baffle member 96 is provided adjacent the body portion 80 to provide additional insulation e.g. thermal or acoustic insulation. The baffle member 96 comprises an insulating material, for example an acoustically insulating material or a thermally insulating material. The baffle member 96 may comprise one or more perforations (not illustrated) to allow penetration of sound, fire, smoke, heat and the like into the baffle member 96 to improve the insulation properties.

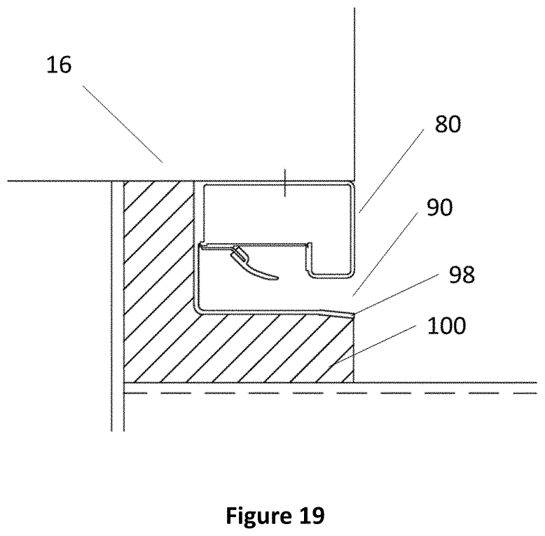

Guide members 16 may further comprise an insulating member 100. As illustrated in FIG. 19, the insulating member 100 substantially surrounds the portion 98 and/or the reversibly attachable bracket 86 of the guide member 16, to provide additional insulation to the channel 90 and cavity 94. Channel 90 is open to receive the rolling shutter door 4. The insulating member 100 may be made of any suitable insulating material, preferably an acoustically insulating material.

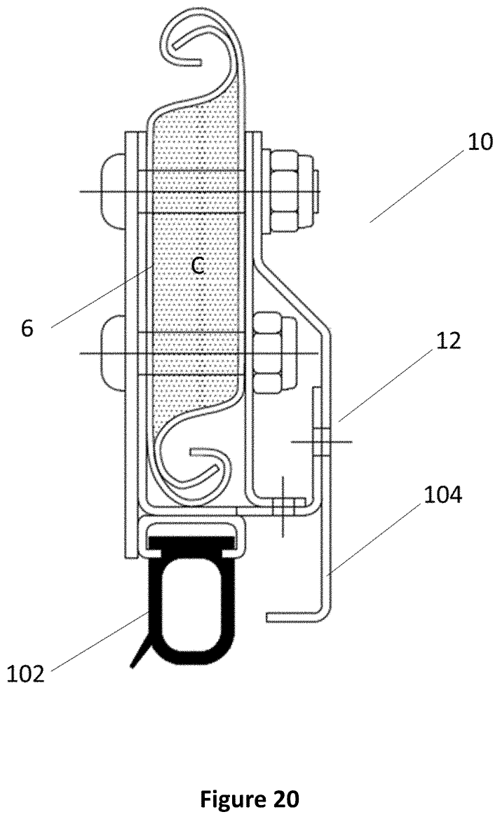

The bottom rail 10 may be provided with a bottom seal 102, to provide further insulation. As illustrated in FIG. 20, the bottom seal 102 may be made of a suitable insulating material, for example an acoustically insulating material or a thermally insulating material.

The blocking member 20 may comprise a lip 104, which protrudes outwardly and downwardly towards the direction of the floor to provide additional protection to the bottom seal 102 from, for example, user impact, fire, sound, smoke, heat and the like. The blocking member 20 can be made of a reinforced material to provide additional strength to the bottom rail 10, and to the rolling shutter door 4. In addition, the lip 104 can support the base of the rolling shutter door 4 when in the closed position, thus preventing the seal 102 from being compressed or damaged.

1-25. (canceled)

26. A door assembly for an opening in a building, wherein the door assembly is installable to the opening, the door assembly comprising:
a rolling shutter door moveable between a closed position wherein the opening is occluded by the rolling shutter door, and an open position wherein the opening is at least partially clear of occlusion by the rolling shutter door; and
a sealing assembly for sealing a gap between the rolling shutter door, the opening, and a surface of the building proximal the opening, the seal comprising:
a resiliently deformable member; and
a sealing member;
wherein the resiliently deformable member and sealing member are each mutually positioned such that the resiliently deformable member co-operates with the sealing member when the rolling shutter door is in the closed position to seal the gap.

27. A door assembly according to claim 26, wherein the resiliently deformable member comprises a resiliently deformable sheet, and wherein the resiliently deformable member is positioned on a surface of the rolling shutter door.

28. A door assembly according to claim 27, wherein the surface of the rolling shutter door faces the exterior of the building when in a closed position, and wherein the resiliently deformable member is positioned on an upper portion of the surface of the rolling shutter door.

29. A door assembly according to claim 26, wherein the sealing member is positioned on an interior wall of the building, proximal the opening therein, wherein the resiliently deformable member has a sealing configuration when the rolling shutter door is in the closed position, and a non-sealing configuration when the rolling shutter door is in the open position.

30. A door assembly according to claim 29, wherein the sealing member is positioned above the opening, and wherein the resiliently deformable member protrudes from the surface of the rolling shutter door in the sealing configuration.

31. A door assembly according to claim 29, wherein in the non-sealing configuration of the resiliently deformable member is complementary to an arcuate conformation of the rolling shutter door when the rolling shutter door is in the open position.

32. A door assembly according to claim 26, wherein the sealing member has a mating configuration when the rolling shutter door is in the closed position, and a resting configuration when the rolling shutter door is in the open position, and wherein the mating configuration of the sealing member is complementary to the sealing configuration of the resiliently deformable member.

33. A door assembly according to claim 32, wherein the sealing member protrudes towards the interior of the building when the sealing member is in the resting configuration, and wherein the resiliently deformable member is a resiliently deformable sheet.

34. A door assembly according to claim 26, wherein the sealing member is resiliently deformable, and wherein in use, when the resiliently deformable member cooperates with the sealing member, the resiliently deformable member causes the sealing member to deform, and, wherein the sealing member comprises a cavity

35. A door assembly according to claim 34, wherein the cavity is at least partially filled with an insulating material selected from an acoustically insulating material, a thermally insulating material, a fire-retardant material, and combinations thereof.

36. A door assembly according to claim 26, wherein the rolling shutter door comprises a plurality of laths, wherein one or more of the laths comprises a cavity, and wherein the cavity is at least partially filled with an acoustically insulating material.

37. A door assembly according to claim 26, further comprising:
a first guide member and a second guide member for guiding the rolling shutter door between the open position and the closed position; and
a barrel positioned between the guides for supporting the rolling shutter door, the barrel being configured to rotate and receive more of the rolling shutter door when said door is rolled to the open position.

38. A door assembly according to claim 37, wherein the opening is defined by two opposing side walls, a top wall and an opposing bottom wall, and wherein the first guide member and the second guide member are positioned:
(i) relative to the opposing side walls; or
(ii) relative to the opposing top and bottom walls;
to guide the rolling shutter door.

39. A door assembly according to claim 37, wherein at least one of the first guide member and the second guide member comprises one or more guide sealing members, wherein the one or more guide sealing members contact the rolling shutter door when in the closed position, and, wherein at least one of the first guide member and the second guide member comprises a reversibly attachable bracket.

40. A door assembly according to claim 37, wherein at least one of the first guide member and the second guide member comprises a cavity, and wherein the cavity is at least partially filled with an insulating material and/or an acoustically insulating material.

41. A method of sealing a gap between a rolling shutter door of a door assembly and an opening in a building to which the door assembly is installed, wherein the rolling shutter door is moveable between a closed position wherein the opening is occluded by the rolling shutter door, and an open position wherein the opening is at least partially clear of occlusion by the rolling shutter door, the method comprising:
providing a resiliently deformable member;
providing a sealing member;
positioning each of the resiliently deformable member and the sealing member relative to one, or the other, of the door assembly and the opening in the building; such that the resiliently deformable member co-operates with the sealing member when the rolling shutter door is in a closed position to seal the gap.

42. A method according to claim 41, the method further comprising:
positioning the resiliently deformable member on the rolling shutter door of the door assembly;
positioning the sealing member on a wall of the building proximal the opening.

43. A sealing member for providing a seal in a door assembly, the door assembly being installed to an opening in a building, and comprising a rolling shutter door moveable between a closed position wherein the opening is occluded by the rolling shutter door, and an open position wherein the opening is at least partially clear of occlusion by the rolling shutter door;
the sealing member comprising:
a resiliently deformable mating member;
a support frame, for supporting the resiliently deformable member; and
means for fixing the sealing member to a wall of the building defining the opening.

44. A sealing member according to claim 43, wherein the sealing member comprises a cavity, wherein the cavity is at least partially filled with an insulating material and/or an acoustically insulating material.

45. A sealing assembly kit for providing a seal to a door assembly, the door assembly being installed to an opening in a building, and comprising a rolling shutter door moveable between a closed position wherein the opening is occluded by the rolling shutter door, and an open position wherein the opening is at least partially clear of occlusion by the rolling shutter door;
the kit comprising:
a sealing member according to claim 43; and
a resiliently deformable member, configured to be positioned on an exterior surface of the rolling shutter door.
